(19) United States
(12) Patent Application Publication
(10) Pub. No.: US 2022/0345681 A1
(43) Pub. Date: Oct. 27, 2022

(54) METHOD AND APPARATUS FOR ENCODING, TRANSMITTING AND DECODING VOLUMETRIC VIDEO

(71) Applicant: InterDigital VC Holdings France, SAS, Cesson-Sevigne (FR)

(72) Inventors: Julien Fleureau, Rennes (FR); Bertrand Chupeau, Rennes (FR); Thierry Tapie, Rennes (FR); Gerard Briand, Ploufragan (FR)

(21) Appl. No.: 17/765,549

(22) PCT Filed: Oct. 1, 2020
(86) PCT No.: PCT/EP2020/077588

§ 371 Date: Mar. 31, 2022

(30) Foreign Application Priority Data
Oct. 2, 2019 (EP) 19306269.2

(51) Int. Cl. H04N 13/161; G06T 9/00; H04N 13/111; G06T 7/55; G06T 7/80

(52) U.S. Cl. CPC H04N 13/161; G06T 9/00; H04N 13/111; G06T 7/55; G06T 7/80

(57) ABSTRACT

Methods, devices and stream for encoding, decoding and transmitting a multi-views frame are disclosed. In a multi-views frame some of the views are more trustable than others. The multi-views frame is encoded in a data stream in association with metadata that comprise, for at least one of the views, a parameter indicating a degree of confidence in the information carried by this view. This information is used at the decoding side to determine the contribution of the view when synthetizing pixels of a viewport frame for a given point of view in the 3D space.

### 1. TECHNICAL FIELD

The present principles generally relate to the domain of three-dimensional (3D) scene and volumetric video content. The present document is also understood in the context of the encoding, the formatting and the decoding of data representative of the texture and the geometry of a 3D scene for a rendering of volumetric content on end-user devices such as mobile devices or Head-Mounted Displays (HMD). Among other themes, the present principles relate to pruning pixels of a multi-views image to guarantee an optimal bitstream and rendering quality.

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Recently there has been a growth of available large field-of-view content (up to 360°). Such content is potentially not fully visible by a user watching the content on immersive display devices such as Head Mounted Displays, smart glasses, PC screens, tablets, smartphones and the like. That means that at a given moment, a user may only be viewing a part of the content. However, a user can typically navigate within the content by various means such as head movement, mouse movement, touch screen, voice and the like. It is typically desirable to encode and decode this content.

Immersive video, also called 360° flat video, allows the user to watch all around himself through rotations of his head around a still point of view. Rotations only allow a 3 Degrees of Freedom (3DoF) experience. Even if 3DoF video is sufficient for a first omnidirectional video experience, for example using a Head-Mounted Display device (HMD), 3DoF video may quickly become frustrating for the viewer who would expect more freedom, for example by experiencing parallax. In addition, 3DoF may also induce dizziness because of a user never only rotates his head but also translates his head in three directions, translations which are not reproduced in 3DoF video experiences.

A large field-of-view content may be, among others, a three-dimension computer graphic imagery scene (3D CGI scene), a point cloud or an immersive video. Many terms might be used to design such immersive videos: Virtual Reality (VR), 360, panoramic, 47π steradians, immersive, omnidirectional or large field of view for example.

Volumetric video (also known as 6 Degrees of Freedom (6DoF) video) is an alternative to 3DoF video. When watching a 6DoF video, in addition to rotations, the user can also translate his head, and even his body, within the watched content and experience parallax and even volumes. Such videos considerably increase the feeling of immersion and the perception of the scene depth and prevent from dizziness by providing consistent visual feedback during head translations. The content is created by the means of dedicated sensors allowing the simultaneous recording of color and depth of the scene of interest. The use of rig of color cameras combined with photogrammetry techniques is a way to perform such a recording, even if technical difficulties remain.

While 3DoF videos comprise a sequence of images resulting from the un-mapping of texture images (e.g. spherical images encoded according to latitude/longitude projection mapping or equirectangular projection mapping), 6DoF video frames embed information from several points of views. They can be viewed as a temporal series of point clouds resulting from a three-dimension capture. Two kinds of volumetric videos may be considered depending on the viewing conditions. A first one (i.e. complete 6DoF) allows a complete free navigation within the video content whereas a second one (aka. 3DoF+) restricts the user viewing space to a limited volume called viewing bounding box, allowing limited translation of the head and parallax experience. This second context is a valuable trade-off between free navigation and passive viewing conditions of a seated audience member.

3DoF+ contents may be provided as a set of Multi-View+Depth (MVD) frames. Such contents may have been captured by dedicated cameras or can be generated from existing computer graphics (CG) contents by means of dedicated (possibly photorealistic) rendering. Volumetric information is conveyed as a combination of color and depth patches stored in corresponding color and depth atlases which are video encoded making use of regular codecs (e.g. HEVC). Each combination of color and depth patches represents a subpart of the MVD input views and the set of all patches is designed at the encoding stage to cover the entire.

The information carried by different views of a MVD frame is variable. There is a lack of a method taking a degree of confidence in the information carried by views of a MVD for the synthetizing of a viewport frame.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate a method for encoding a multi-views frame. The method comprises:
for a view of said multi-views frame, obtaining a parameter representative of fidelity of depth information carried by said view; and
encoding said multi-views frame in a data stream in association with metadata comprising said parameters.

In a particular embodiment, the parameter representative of fidelity of depth information of a view is determined according to the intrinsic and extrinsic parameters of a camera having captured the view. In another embodiment, the metadata comprise an information indicating whether a parameter is provided for each view of the multi-views frame and, if so, for each view, the parameter associated to the view. In a first embodiment of the present principles, a parameter representative of fidelity of depth information of a view is a Boolean value indicating whether the depth fidelity is fully trustable or partially trustable. In a second embodiment of the present principles, a parameter representative of fidelity of depth information of a view is a numerical value indicating a confidence in the depth fidelity of the view.

The present principles also relate to a device comprising a processor configured to implement this method.

The present principles also relate to a method for decoding a multi-views frame from a data stream. The method comprises:
decoding said multi-views frame and associated metadata from the data stream;
from the metadata, obtaining an information indicating whether a parameter representative of fidelity in depth information carried by a view of said multi-views frame is provided and, if so, obtaining a parameter for each view; and
generating a viewport frame according to a viewing pose by determining a contribution of each view of said multi-views frame as a function of the parameter associated with the view.

In an embodiment, wherein a parameter representative of fidelity of depth information of a view is a Boolean value indicating whether the depth fidelity is fully trustable or partially trustable. In a variant of this embodiment, the contribution of a partially trustable view is ignored. In a further variant, on condition that multiple views are fully trustable, the fully trustable view with the lowest depth information is used. In another embodiment, a parameter representative of fidelity of depth information of a view is a numerical value indicating a confidence in the depth fidelity of the view. In a variant of this embodiment, the contribution of each view during the view synthesis is proportional to the numeric value of the parameter.

The present principles also relate to a device comprising a processor configured to implement this method.

The present principles also relate to data stream comprising:
data representative of a multi-views frame; and
metadata associated with said data, the metadata comprising, for each view of the multi-views frame, a parameter representative of fidelity of depth information carried by said view.

### 4. BRIEF DESCRIPTION OF DRAWINGS

The present disclosure will be better understood, and other specific features and advantages will emerge upon reading the following description, the description making reference to the annexed drawings wherein:

FIG. 1 shows a three-dimension (3D) model of an object and points of a point cloud corresponding to the 3D model, according to a non-limiting embodiment of the present principles;

FIG. 2 shows a non-limitative example of the encoding, transmission and decoding of data representative of a sequence of 3D scenes, according to a non-limiting embodiment of the present principles;

FIG. 3 shows an example architecture of a device which may be configured to implement a method described in relation with FIGS. 7 and 8, according to a non-limiting embodiment of the present principles;

FIG. 4 shows an example of an embodiment of the syntax of a stream when the data are transmitted over a packet-based transmission protocol, according to a non-limiting embodiment of the present principles;

FIG. 5 illustrates a process used by a view synthesizer when generating an image for a given viewport from a non-pruned MVD frame, according to a non-limiting embodiment of the present principles;

FIG. 6 illustrates a view synthesizing for a set of cameras with heterogeneous sampling of the 3D space, according to a non-limiting embodiment of the present principles;

FIG. 7 illustrates a method 70 for encoding a multi-view frame in a data stream, according to a non-limiting embodiment of the present principles;

FIG. 8 illustrates a method for decoding a multi-view frame from a data stream, according to a non-limiting embodiment of the present principles.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as“/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

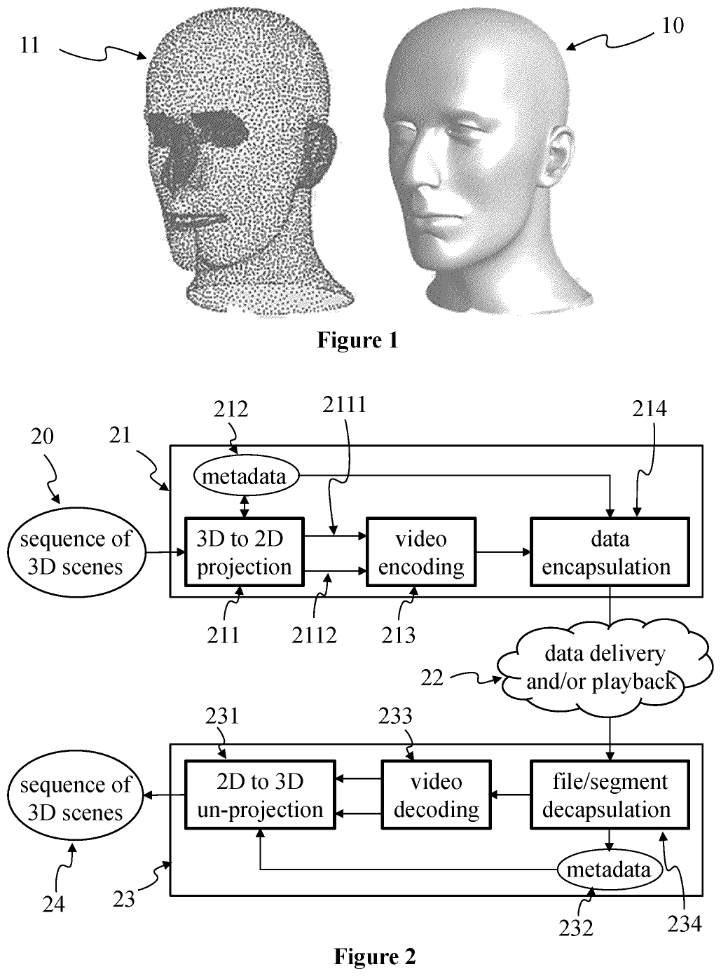

FIG. 1 shows a three-dimension (3D) model 10 of an object and points of a point cloud 11 corresponding to 3D model 10. 3D model 10 and the point cloud 11 may for example correspond to a possible 3D representation of an object of the 3D scene comprising other objects. Model 10 may be a 3D mesh representation and points of point cloud 11 may be the vertices of the mesh. Points of point cloud 11 may also be points spread on the surface of faces of the mesh. Model 10 may also be represented as a splatted version of point cloud 11, the surface of model 10 being created by splatting the points of the point cloud 11. Model 10 may be represented by a lot of different representations such as voxels or splines. FIG. 1 illustrates the fact that a point cloud may be defined with a surface representation of a 3D object and that a surface representation of a 3D object may be generated from a point of cloud. As used herein, projecting points of a 3D object (by extension points of a 3D scene) onto an image is equivalent to projecting any representation of this 3D object, for example a point cloud, a mesh, a spline model or a voxel model.

A point cloud may be represented in memory, for instance, as a vector-based structure, wherein each point has its own coordinates in the frame of reference of a viewpoint (e.g. three-dimensional coordinates XYZ, or a solid angle and a distance (also called depth) from/to the viewpoint) and one or more attributes, also called component. An example of component is the color component that may be expressed in various color spaces, for example RGB (Red, Green and Blue) or YUV (Y being the luma component and UV two chrominance components). The point cloud is a representation of a 3D scene comprising objects. The 3D scene may be seen from a given viewpoint or a range of viewpoints. The point cloud may be obtained by many ways, e.g.:
from a capture of a real object shot by a rig of cameras, optionally complemented by depth active sensing device;
from a capture of a virtual/synthetic object shot by a rig of virtual cameras in a modelling tool;
from a mix of both real and virtual objects.

A 3D scene, in particular when prepared for a 3DoF+ rendering may be represented by a Multi-View+Depth (MVD) frame. A volumetric video is then a sequence of MVD frames. In this approach, the volumetric information is conveyed as a combination of color and depth patches stored in corresponding color and depth atlases which are then video encoded making use of regular codecs (typically HEVC). Each combination of color and depth patches typically represents a subpart of the MVD input views and the set of all patches is designed at the encoding stage to cover the entire scene while being as less redundant as possible. At the decoding stage, the atlases are first video decoded and the patches are rendered in a view synthesis process to recover the viewport associated to a desired viewing position.

FIG. 2 shows a non-limitative example of the encoding, transmission and decoding of data representative of a sequence of 3D scenes. The encoding format that may be, for example and at the same time, compatible for 3DoF, 3DoF+ and 6DoF decoding.

A sequence of 3D scenes 20 is obtained. As a sequence of pictures is a 2D video, a sequence of 3D scenes is a 3D (also called volumetric) video. A sequence of 3D scenes may be provided to a volumetric video rendering device for a 3DoF, 3Dof+ or 6DoF rendering and displaying.

Sequence of 3D scenes 20 is provided to an encoder 21. The encoder 21 takes one 3D scenes or a sequence of 3D scenes as input and provides a bit stream representative of the input. The bit stream may be stored in a memory 22 and/or on an electronic data medium and may be transmitted over a network 22. The bit stream representative of a sequence of 3D scenes may be read from a memory 22 and/or received from a network 22 by a decoder 23. Decoder 23 is inputted by said bit stream and provides a sequence of 3D scenes, for instance in a point cloud format.

Encoder 21 may comprise several circuits implementing several steps. In a first step, encoder 21 projects each 3D scene onto at least one 2D picture. 3D projection is any method of mapping three-dimensional points to a two-dimensional plane. As most current methods for displaying graphical data are based on planar (pixel information from several bit planes) two-dimensional media, the use of this type of projection is widespread, especially in computer graphics, engineering and drafting. Projection circuit 211 provides at least one two-dimensional frame 2111 for a 3D scene of sequence 20. Frame 2111 comprises color information and depth information representative of the 3D scene projected onto frame 2111. In a variant, color information and depth information are encoded in two separate frames 2111 and 2112.

Metadata 212 are used and updated by projection circuit 211. Metadata 212 comprise information about the projection operation (e.g. projection parameters) and about the way color and depth information is organized within frames 2111 and 2112 as described in relation to FIGS. 5 to 7.

A video encoding circuit 213 encodes sequence of frames 2111 and 2112 as a video. Pictures of a 3D scene 2111 and 2112 (or a sequence of pictures of the 3D scene) is encoded in a stream by video encoder 213. Then video data and metadata 212 are encapsulated in a data stream by a data encapsulation circuit 214.

Encoder 213 is for example compliant with an encoder such as:
JPEG, specification ISO/CEI 10918-1 UIT-T Recommendation T.81, https://www.itu.int/rec/T-REC-T.81/en;
AVC, also named MPEG-4 AVC or h264. Specified in both UIT-T H.264 and ISO/CEI MPEG-4 Part 10 (ISO/CEI 14496-10), http://www.itu.int/rec/T-REC-H.264/en, HEVC (its specification is found at the ITU website, T recommendation, H series, h265, http://www.itu.int/rec/T-REC-H.265-201612-I/en);
3D-HEVC (an extension of HEVC whose specification is found at the ITU website, T recommendation, H series, h265, http://www.itu.int/rec/T-REC-H.265-201612-I/en annex G and I);
VP9 developed by Google;
AV1 (AOMedia Video 1) developed by Alliance for Open Media; or
Future standards like Versatile Video Coder or MPEG-I or MPEG-V future versions.

The data stream is stored in a memory that is accessible, for example through a network 22, by a decoder 23. Decoder 23 comprises different circuits implementing different steps of the decoding. Decoder 23 takes a data stream generated by an encoder 21 as an input and provides a sequence of 3D scenes 24 to be rendered and displayed by a volumetric video display device, like a Head-Mounted Device (HMD). Decoder 23 obtains the stream from a source 22. For example, source 22 belongs to a set comprising:
a local memory, e.g. a video memory or a RAM (or Random-Access Memory), a flash memory, a ROM (or Read Only Memory), a hard disk;
a storage interface, e.g. an interface with a mass storage, a RAM, a flash memory, a ROM, an optical disc or a magnetic support;
a communication interface, e.g. a wireline interface (for example a bus interface, a wide area network interface, a local area network interface) or a wireless interface (such as a IEEE 802.11 interface or a Bluetooth® interface); and
a user interface such as a Graphical User Interface enabling a user to input data.

Decoder 23 comprises a circuit 234 for extract data encoded in the data stream. Circuit 234 takes a data stream as input and provides metadata 232 corresponding to metadata 212 encoded in the stream and a two-dimensional video. The video is decoded by a video decoder 233 which provides a sequence of frames. Decoded frames comprise color and depth information. In a variant, video decoder 233 provides two sequences of frames, one comprising color information, the other comprising depth information. A circuit 231 uses metadata 232 to un-project color and depth information from decoded frames to provide a sequence of 3D scenes 24. Sequence of 3D scenes 24 corresponds to sequence of 3D scenes 20, with a possible loss of precision related to the encoding as a 2D video and to the video compression.

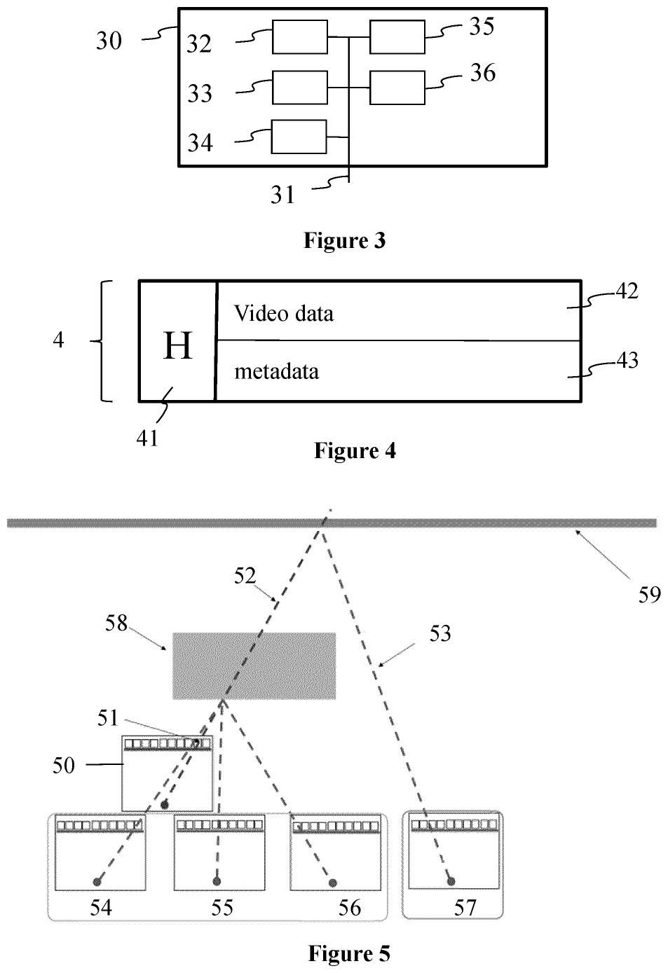

FIG. 3 shows an example architecture of a device 30 which may be configured to implement a method described in relation with FIGS. 7 and 8. Encoder 21 and/or decoder 23 of FIG. 2 may implement this architecture. Alternatively, each circuit of encoder 21 and/or decoder 23 may be a device according to the architecture of FIG. 3, linked together, for instance, via their bus 31 and/or via I/O interface 36.

Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply, e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

In accordance with examples, the device 30 is configured to implement a method described in relation with FIGS. 7 and 8, and belongs to a set comprising:
a mobile device;
a communication device;
a game device;
a tablet (or tablet computer);
a laptop;
a still picture camera;
a video camera;
an encoding chip;
a server (e.g. a broadcast server, a video-on-demand server or a web server).

FIG. 4 shows an example of an embodiment of the syntax of a stream when the data are transmitted over a packet-based transmission protocol. FIG. 4 shows an example structure 4 of a volumetric video stream. The structure consists in a container which organizes the stream in independent elements of syntax. The structure may comprise a header part 41 which is a set of data common to every syntax elements of the stream. For example, the header part comprises some of metadata about syntax elements, describing the nature and the role of each of them. The header part may also comprise a part of metadata 212 of FIG. 2, for instance the coordinates of a central point of view used for projecting points of a 3D scene onto frames 2111 and 2112. The structure comprises a payload comprising an element of syntax 42 and at least one element of syntax 43. Syntax element 42 comprises data representative of the color and depth frames. Images may have been compressed according to a video compression method.

Element of syntax 43 is a part of the payload of the data stream and may comprise metadata about how frames of element of syntax 42 are encoded, for instance parameters used for projecting and packing points of a 3D scene onto frames. Such metadata may be associated with each frame of the video or to group of frames (also known as Group of Pictures (GoP) in video compression standards).

3DoF+ contents may be provided as a set of Multi-View+Depth (MVD) frames. Such contents may have been captured by dedicated cameras or can be generated from existing computer graphics (CG) contents by means of dedicated (possibly photorealistic) rendering.

FIG. 5 illustrates a process used by a view synthesizer 231 of FIG. 2 when generating an image for a given viewport from a MVD frame. When trying to synthesize a pixel 51 for a viewport 50 to synthesize, a synthesizer (e.g. circuit 231 of FIG. 2) un-projects a ray (e.g. rays 52 and 53) passing by this given pixel and checks out the contribution of each source camera 54 to 57 along this ray. As illustrated in FIG. 5, when some objects in the scene create occlusions from one camera to another or when visibility cannot be ensured due to the camera setup, a consensus between all source cameras 54 to 57 regarding the properties of the pixel to synthesize may not be found. In the example of FIG. 5, a first group of 3 cameras 54 to 56 “vote” to use the color of the foreground object 58 to synthesize pixel 51 as they all “see” this object along the ray to synthesize. A second group of one single camera 57 cannot see this object because it is outside of its viewport. Thus, camera 57 “votes” for the background object 59 to synthesize pixel 51. A strategy to disambiguate such a situation is to blend and/or merge each camera contribution by a weight depending on their distance to the viewport to synthesize. In the example of FIG. 5, the first group of cameras 54 to 56 brings the biggest contribution as they are more numerous and as they are closer from the viewport to synthesize. In the end, pixel 51 would be synthesized making use of the properties of the foreground object 68, as expected.

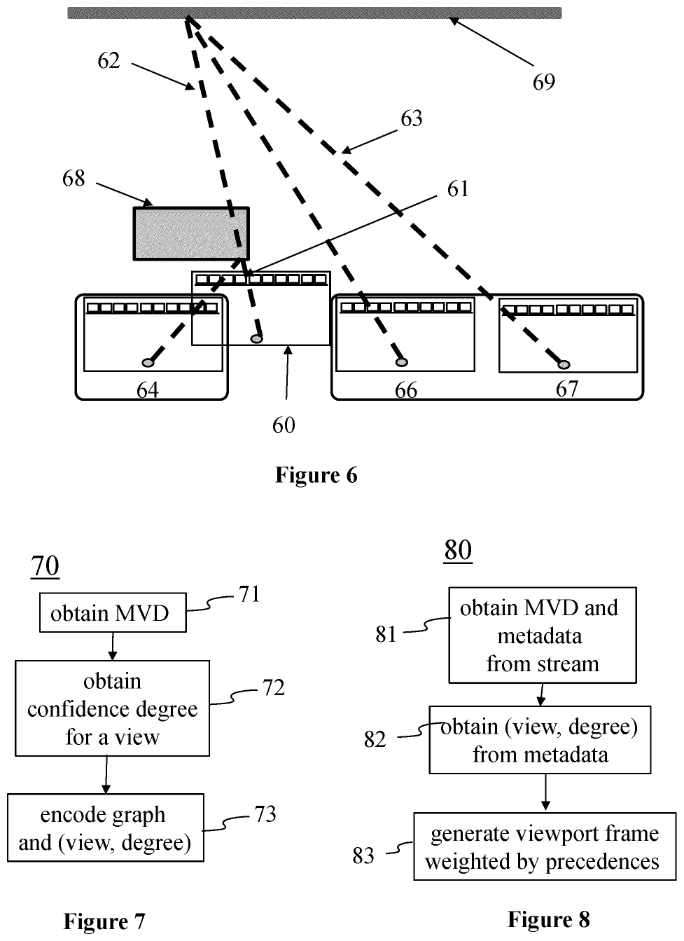

FIG. 6 illustrates a view synthesizing for a set of cameras with heterogeneous sampling of the 3D space. Depending on the configuration of the source camera rig, especially when the volumetric scene to acquire is not sampled optimally, this weighting strategy may fail as it may be observed in FIG. 6. In such a situation the rig is clearly badly sampled to capture the object as most of the input cameras cannot see it and a simple weighting strategy would not give the expected result. In the example of FIG. 6, foreground object 68 is captured only by camera 64. When trying to synthesize a pixel 61 for viewport 60 to synthesize, the synthesizer un-projects a ray (e.g. rays 62 and 63) passing by this given pixel and checks out the contribution of each source camera 64, 66 and 67 along this ray. In the example of FIG. 6, cameras 64 vote to use the color of foreground object 68 to synthesize pixel 61 while the group of cameras 66 and 67 vote for background object 69 to synthesize pixel 61. In the end, the contribution of the color of background object 69 is bigger than the contribution of the color of foreground object 68, leading to visual artifacts.

Even if one could argue that a bad sampling of the scene to acquire could be overcome at the capture stage by adapting the spatial configuration of the cameras, scenario where one cannot anticipate the geometry of the scene may happen for example in live streaming. Furthermore, in the case of a natural scene with complex motions and a high number of possible occlusions, finding a perfect rig setup is almost impossible.

However, in some specific scenarios, especially when virtual rigs of cameras are used to capture computer generated (CG) 3D scenes, one may envision other weighting strategies than the one presented previously as virtual cameras are “perfect” and they can be fully trusted. Indeed, in a real (non-CG) context, the MVD that serves as input for the volumetric scene has to be estimated because the depth information is not directly captured and has to be computed beforehand by photogrammetry approaches for instance. This latter step is the source of a lot of artifacts (especially non-consistency between the geometric information of distant cameras) which then have/require to be mitigated by a weighting/voting strategy similar to the one described in FIG. 5. On the contrary, in computer generated scenario, the scene to acquire is fully modelized and such artifacts cannot happen because the depth information is directly given by the models in a perfect manner. When a synthesizer knows beforehand that it should fully trust the information given by a source (View+Depth), then it can considerably speed up its process and prevent from weighting issue as the one described in FIG. 6.

According to the present principles, a normative approach to overcome these drawbacks is proposed. An information is inserted metadata transmitted to the decoder to indicate to the synthesizer that the cameras used for the synthesis are trustable and that an alternative weighting should be envisioned. A degree of confidence in the information carried by each view of the multi-views frame is encoded in metadata associated with the multi-views frame. The degree of confidence is related to the fidelity of the depth information as acquired. As detailed upper, for a view captured by a virtual camera, the fidelity of the depth information is maximal and, for a view captured by real camera, the fidelity of the depth information depends on the intrinsic and extrinsic parameters of the real camera.

An implementation of such a feature may be done by the insertion of a flag in a camera parameter list in the metadata as described in Table 1. This flag may be a boolean value per camera enabling a special profile of the view synthesizer where it is able to consider that the given camera is a perfect one and that its information should be considered as fully trustable, as explained before.

General flag “source_confidence_params_equal_flag” is set. This flag is representative of enabling (if true) or disabling (if false) the feature and ii) in the case the latter flag is enabled, an array of boolean values “source_confidence” where each component indicates for each camera if it has to be considered as fully reliable (if true) or not (if false) is inserted in the metadata.

TABLE 1

| | Descriptor |
|---|---|
| camera params list() { | |
| num_cameras_minus1 | u(16) |

for ( i= 0; i <= num cameras minusl; i++) {

| | |
|---|---|
| cam_pos_x[ i ] | u(32) |
| cam_pos_y[ i ] | u(32) |
| cam_pos_z[ i ] | u(32) |
| cam_yaw[i ] | u(32) |
| cam_pitch[ i ] | u(32) |
| cam_roll[ i ] | u(32) |

}

| | |
|---|---|
| intrinsic_params_equal_flag | u(1) |

```
  for ( i = 0; i <= intrinsic_params_equal_flag ? 0 : num_cameras_minus1; i++ )
    camera_intrinsics( [ i ] )
```

| | |
|---|---|
| depth_quantization_params_equal_flag | u(1) |

```
  for ( i = 0; i <= depth_quantization_equal_flag ? 0 : num_cameras_minus1; i++ )
    depth_quantization( [ i ] )
```

| | |
|---|---|
| source_confidence_params_equal_flag | u(1) |

for ( i = 0; i <= source_confidence_params_equal_flag ? 0 : num_cameras_minus1; i++ )

| | |
|---|---|
| source_confidence[ i ] | u(1) |

At the rendering stage, if a camera is identified as fully trustable (associated component of source_confidence set to true) then its geometry information (depth values) overrides all the geometry information carried by the other “non-trustable” (i.e. regular) cameras. In that case, the weighting scheme can be advantageously replaced by a simple selection of the geometry (e.g. depth) information of the camera identified as reliable. In other words, in the weighting/voting scheme proposed in FIGS. 5 and 6, if a consensus on the position of the point that should be kept (foreground or background) for the synthesis of a given pixel cannot be found between a camera having its source_confidence property to true and another having its source_confidence property to false, then the one having its source_confidence enabled is preferred.

When multiple cameras have this property enabled (associated component of source_confidence set to true), for a given pixel to synthesize, then the camera(s) which depth information is the smallest is selected, as it may be performed in the depth buffer of a regular rasterization engine. Such a choice is motivated by the fact that if a given reliable camera has seen an object closer than the other cameras for a given pixel to synthesize, then, necessarily, it creates an occlusion for the other cameras which therefore carry the information of an occluded further object. In FIG. 6, such a strategy would come down to selecting the information carried by the camera 64 as the one to use for the synthesis of pixel 61.

In another embodiment, a non-binary value is used for the source_confidence such as a normalized floating point between 0 and 1 indicating how “trustable” the camera should be considered in the rendering scheme.

In a real-world environment, the cameras would not typically be considered to be fully trustable and perfect. Recall, that the terms “fully trustable” and “perfect” are referring generally to the depth information. In a CG environment, the depth information is known because it is generated according to models. Thus, the depth is known for all of the objects with respect to all of the virtual cameras. Such virtual cameras are modeled as being part of a virtual rig that is generated inside of the CG environment. Accordingly, the virtual cameras are fully trustable and perfect.

In the example of FIG. 6, if the cameras are part of a real-world system, and the depth is estimated, then the cameras would not be expected to be fully trustable and perfect. Thus, if a majority weighting scheme is used for pixel 61 of viewport camera 60, then the answer produced would be a background color for pixel 61. Similarly, if the cameras are part of a virtual rig and are fully trustable and perfect, but a majority weighting scheme is still used, then the background color will still be selected for pixel 61. However, if the cameras are part of a virtual rig, and their fully trustable state is used so that the lowest depth of the fully trustable cameras is selected, then the foreground color (from camera 64) is selected for pixel 61.

CG movies can benefit from the embodiments described. For example, a CG movie (e.g. Lion King) could be reshot using a virtual rig with multiple virtual cameras providing multiple views. The resulting output would allow a user to have an immersive experience in the movie, selecting the viewing position. Rendering the different viewing positions is typically time intensive. However, given that the virtual cameras are fully trustable and perfect (with respect to depth), the rendering time can be reduced, for example, by allowing the lowest depth camera to provide the color for a given pixel or alternatively, an average value of the colors of the closer depth values. This eliminates the processing typically needed to perform a weighting operation.

The concept of trust may be extended to real-world cameras. However, reliance on a single real-world camera based on estimated depth brings a risk that the wrong color will be selected for any given pixel. However, if certain depth information is more reliable, for a given camera, then this information may be leveraged to reduce rendering time but also to improve the final quality by relying on the “best” cameras and thus avoiding possible artifacts.

Complementarily, in addition to a perfect geometric information, a “fully trustable” camera could be also used to carry the reliability of a color information among the different cameras of the rig. It is well known that calibrating different cameras in terms of color information is not always easy to achieve. The “fully trustable” camera concept could be thus also used to identify a camera as a color reference to trust more at the color weighted rendering stage.

FIG. 7 illustrates a method 70 for encoding a multi-view (MV) frame in a data stream according to a non-limiting embodiment of the present principles. At a step 71, a multi-views frame is obtained from a source. At a step 72, a parameter representative of a degree of confidence in information carried by a given view of the multi-views frame is obtained. In an embodiment, a parameter is obtained for every view of the MV frame. This parameter may be a Boolean value indicating whether the information of the view is fully trustable or “non-fully” trustable. In a variant, the parameter is a degree of confidence in a range of degrees, for instance an integer between −100 and 100 or between 0 and 255 or a real number, for instance between −1.0 and 1.0 or between 0.0 and 1.0. At a step 73, the MV frame is encoded in a data stream in association with metadata. The metadata comprise pairs of data associating a view, for instance an index, with its parameter.

FIG. 8 illustrates a method 80 for decoding a multi-view frame from a data stream according to a non-limiting embodiment of the present principles. At a step 81, a multi-views frame is decoded from a stream. Metadata associated with this MV frame are also decoded from the stream. At a step 82, pairs of data are obtained from the metadata, these data associating a view of the MV frame with a parameter representative of a degree of confidence in the information carried by this view. At a step 73, a viewport frame is generated for a viewing pose (i.e. location and orientation in the 3D space of the renderer). For pixels of the viewport frames, the weight of the contribution of each view (also called ‘camera’ in the present application) is determined according to the degree of confidence associated with each views.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method comprising:
for a view of a multi-view frame, obtaining a parameter representative of fidelity of depth information carried by said view, wherein the parameter is a Boolean value indicating whether the fidelity of depth information is fully trustable or a numerical value indicating a confidence in the fidelity of depth information of the view; and
encoding said multi-view frame in a data stream in association with metadata comprising said parameters.

2. The method of claim 1, wherein the parameter representative of fidelity of depth information of the view is determined according to the intrinsic and extrinsic parameters of a camera having captured the view.

3. The method of claim 1, wherein the metadata comprise information indicating whether a parameter is provided for each view of the multi-view frame and, if so, for each view, the parameter associated with each corresponding view.

4. (canceled)

5. (canceled)

6. A device comprising a processor configured to:
for a view of a multi-view frame, obtain a parameter representative of fidelity of depth information carried by said view, wherein the parameter is a Boolean value indicating whether the fidelity of depth information is fully trustable or a numerical value indicating a confidence in the fidelity of depth information of the view; and
encode said multi-view frame in a data stream in association with metadata comprising said parameters.

7. The device of claim 6, wherein the processor is configured to determine the parameter representative of fidelity of depth information of the view according to the intrinsic and extrinsic parameters of a camera having captured the view.

8. The device of claim 6, wherein the processor is configured to encode metadata comprising information indicating whether a parameter is provided for each view of the multi-view frame and, if so, for each view, the parameter associated with each corresponding view.

9. (canceled)

10. (canceled)

11. A method comprising:
decoding a multi-view frame and associated metadata from a data stream;
from the metadata, obtaining an information indicating whether a parameter representative of fidelity of depth information carried by a view of said multi-view frame is provided and, if so, obtaining a parameter for each corresponding view, wherein the parameter is a Boolean value indicating whether the fidelity of depth information is fully trustable or a numerical value indicating a confidence in the fidelity of depth information of the view; and
generating a viewport frame according to a viewing pose by determining a contribution of each view of said multi-view frame as a function of the parameter associated with the view.

12. (canceled)

13. The method of claim 11, wherein the contribution of a not fully trustable view is ignored.

14. The method of claim 11, wherein, on condition that multiple views are fully trustable, the fully trustable view with the lowest depth information is used.

15. (canceled)

16. The method of claim 11, wherein the contribution of each view is proportional to the numerical value associated with the view.

17. A device comprising a processor configured to:
decode a multi-view frame and associated metadata from a data stream;
from the metadata, obtain an information indicating whether a parameter representative of fidelity of depth information carried by a view of said multi-view frame is provided and, if so, obtaining a parameter for each corresponding view, wherein the parameters is a Boolean value indicating whether fidelity of depth information is fully trustable or a numerical value indicating a confidence in the depth fidelity of the view; and
generate a viewport frame according to a viewing pose by determining a contribution of each view of said multi-view frame as a function of the parameter associated with the view.

18. (canceled)

19. The device of claim 17, wherein the contribution of a not fully trustable view is ignored.

20. The device of claim 17, wherein, on condition that multiple views are fully trustable, the fully trustable view with the lowest depth information is used.

21. (canceled)

22. The device of claim 17, wherein the contribution of each view is proportional to the numerical value associated with the view.

23.-26. (canceled)
